(19) United States
(12) Patent Application Publication
(10) Pub. No.: US 2026/0138347 A1
(43) Pub. Date: May 21, 2026

(54) CARRIER FOR RETAINING AND TRANSPORTING BLANKS, PACKAGING TRAYS AND PACKAGING ITEMS

(71) Applicant: KOCH Pac-Systeme GmbH, Pfalzgrafenweiler (DE)

(72) Inventors: Chris Daniel LUICK, Pfalzgrafenweiler (DE); Marko Fanta, Pfalzgrafenweiler (DE); Michael SCHMIDTKE, Pfalzgrafenweiler (DE)

(21) Appl. No.: 19/393,935

(22) Filed: Nov. 19, 2025

(30) Foreign Application Priority Data
Nov. 20, 2024 (EP) 24 214 150.5

(51) Int. Cl. B31B 50/02; B31B 50/04; B31B 50/44; B31B 50/60

(52) U.S. Cl. CPC B31B 50/022; B31B 50/04; B31B 50/44; B31B 50/60

(57) ABSTRACT

A carrier is formed by a retaining plate having a recess, and a delimiting element which is attached to the lower side of the retaining plate and spans the recess. The recess and the delimiting element form a retainer for a formed blank, an inserted packaging tray or packaging item. The retainer is delimited at the bottom by the at least one delimiting element. In a transverse direction, the delimiting element has a width which is smaller than a dimension of the recess parallel to the transverse direction.

### RELATED APPLICATIONS

The present disclosure claims priority to and the benefit of European Patent Application EP 24214 150.5, filed on November 20, 2024, the entire contents of each of which are incorporated herein by reference.

### FIELD

The present disclosure relates to a carrier for retaining and transporting blanks, packaging trays and packaging items, preferably produced from a fibre-based material, in particular from paper, cardboard, pulp or card, or from plastics, in particular from polyvinyl chloride, polypropylene, polyethylene or another plastic suitable for packaging. The present disclosure further relates to a device and a method for producing packaging items with a carrier of this type.

### BACKGROUND

Sustainability, environmental protection and recycling capabilities are important requirements for products and increasingly also for their packaging. Thus, packaging items are more and more often being formed from a fibre-based material, such as paper, cardboard, pulp or card, or from plastics which are readily suitable for recycling. Packaging machines for producing packaging from fibre-based material are known, in which blanks produced from fibre-based material as well as packaging items formed therefrom are transported on carriers, also known as pallets, through individual processing stations of the packaging machine. Many demands are placed on these carriers because of the various processing stations through which the carriers pass. As an example, when forming and sealing blanks to form a packaging item, these blanks should be sufficiently supported and securely retained in the respective carrier during processing and transporting. Furthermore, the tools which are used should be able to access the blanks readily. Finally, it is desirable for the carriers to be capable of being produced in a simple and cost-effective manner. Known carriers do not meet all of these criteria in a satisfactory manner.

### BRIEF SUMMARY

The present disclosure provides a carrier for retaining and transporting blanks, packaging trays and packaging items, which securely retains and sufficiently supports at least one blank, packaging tray or packaging item during the processing and transport thereof, which provides access for tools, and which at the same time can be manufactured in a simple and cost-effective manner.

According to a first aspect of the present disclosure, a carrier for retaining and transporting blanks, packaging trays and packaging items comprises a retaining plate having at least one recess which penetrates the retaining plate from an upper side to a lower side of the retaining plate, and at least one delimiting element which is attached to the lower side of the retaining plate. The at least one delimiting element spans the at least one recess. The at least one recess and the at least one delimiting element form a retainer for a blank formed into the retainer, an inserted packaging tray or packaging item, the retainer being delimited at a bottom by the at least one delimiting element. Furthermore, the at least one delimiting element has a main direction of extension and a width, wherein the width is defined in a transverse direction perpendicular to the main direction of extension of the at least one delimiting element and is smaller than a dimension of the at least one recess parallel to the transverse direction.

In this manner, a carrier is provided which sufficiently supports blanks, packaging trays and packaging items and therefore, for example, can be formed as a die for forming the blanks or as an abutment when sealing or gluing. The at least one delimiting element reinforces the retaining plate and therefore provides the blanks, packaging trays and packaging items with a stable support during transport, forming and sealing or gluing such as, for example, when sealing or gluing an inlay to a formed blank or when sealing or gluing a cover to the formed blank. The at least one delimiting element is therefore configured in such a way that the blanks or packaging trays are spatially accessible both from the lower side as well as from the sides. In addition, formed blanks and packaging trays are securely and reliably retained in the retainer formed by the at least one recess and the at least one delimiting element for being transported to other processing devices and for being processed therein. Falling of the blanks or packaging trays through the at least one recess during transport or further processing steps such as, for example, forming, filling and sealing or gluing, can be reliably prevented by the at least one delimiting element. Because the width of the at least one delimiting element is smaller than the dimension of the at least one recess parallel to the transverse direction, a blank formed into the retainer or an inserted packaging tray is readily accessible from both sides of the at least one delimiting element, for example for tools for sealing the inlay to a formed blank or for sealing dust flaps of the blank. Finally, the carrier is easy and cost-effective to produce, because the retainers are formed by the at least one recess and the at least one delimiting element attached to the retaining plate. In turn, these components are easy to produce and mount and require little material, because they can be formed separately from plates or sheets and can then be assembled.

Preferably, the main direction of extension and the transverse direction of the at least one delimiting element are parallel to a plane of the retaining plate, and so, for example, parallel to its upper side and/or lower side.

A blank is the starting product for the production of a packaging part such as a receptacle or a packaging tray, or of a packaging item such as a folded box. The blank may initially be flat. The blanks can thus be stored and transported in a space-saving manner prior to processing. A blank may have several sections and/or flaps which can respectively be folded relative to one another along a fold in order to form the packaging part or the packaging item. The blank may, for example, have creases and/or perforations and/or scores which respectively define a fold or a weakness in the material and facilitate folding. The blank may also have any combination of these features. The packaging tray may be formed by forming the blank, or may already be pre-formed and inserted into the carrier.

The blank, the packaging tray or packaging item is preferably formed from a fibre-based material. The fibre-based material preferably contains cellulose. Particularly preferably, the fibre-based material is paper, cardboard, pulp or card. The packaging items, therefore, are particularly environmentally friendly and can be readily recycled. However, the blank, the packaging tray or packaging item can also be formed from a plastic, in particular from polyvinyl chloride, polypropylene, polyethylene or another plastic which is suitable for packaging. Mixed forms can also be envisaged, in which components produced from a fibre-based material and from plastic are combined. As an example, a preformed packaging tray may be produced from plastic and can be connected to a cover card of fibre-based material, or vice versa.

The at least one recess is surrounded by the retaining plate. An edge area of the retaining plate adjoins the recess on each side of the at least one recess. The at least one delimiting element spans the at least one recess, i.e. it extends from a first edge area adjoining the at least one recess to a second edge area opposite the first edge area. Preferably, the at least one delimiting element extends at a distance from other edge areas, for example a third and a fourth edge area, which connect the first and the second edge area. In this manner, the retaining plate can be reinforced in locations in which it is particularly weakened by the at least one recess. In addition, formed blanks, packaging trays and packaging items are therefore also supported at a distance from the edge areas but remain spatially accessible.

Preferably, the carrier comprises a plurality of delimiting elements which are arranged at a distance from each other in the transverse direction. In this way, the delimiting elements may have a small width and therefore ensure good access to a formed blank or an inserted packaging tray or packaging item, while at the same time providing sufficient reinforcement of the retaining plate. In addition, the delimiting elements can be arranged in a flexible manner where an access to the blank, the packaging tray or the packaging item is not subsequently necessary and/or where a particularly high load occurs. All details described herein regarding the at least one delimiting element can be applied in an analogous manner to each delimiting element of the plurality of delimiting elements, and vice versa.

In general, the at least one delimiting element may be in the shape of a strip or a bar. A width of the at least one delimiting element is then substantially smaller than a length and a height of the at least one delimiting element.

In one embodiment, the width of the at least one delimiting element is between 1 mm and 8 mm, preferably between 1 mm and 6 mm, more preferably between 1 mm and 4 mm. Hence, the at least one delimiting element only covers a narrow region of a formed blank, of the packaging tray or packaging item, which remains readily accessible. At the same time, the at least one de-limiting element only requires a small amount of material and can be produced in a simple and cost-effective manner, for example by laser cutting or water jet cutting from a sheet or a plate.

The dimension of the at least one recess parallel to the transverse direction is larger than the width of the at least one delimiting element and, in the case of a plurality of delimiting elements, is larger than the sum of the widths of the plurality of delimiting elements which span the at least one recess. Preferably, the dimension of the at least one recess parallel to the transverse direction is at least double, more preferably at least three times, even more preferably at least four times the width of the at least one delimiting element.

Preferably, the carrier forms a die for fixing the packaging tray or packaging item. It is therefore preferable for a peripheral shape of the at least one recess to correspond with a peripheral shape of the packaging tray or packaging item. The carrier then retains the formed blank, the packaging tray or packaging item in a particularly secure and reliable manner.

Preferably, the at least one recess has an elongated shape and is orientated such that the at least one recess extends further parallel to the transverse direction than parallel to the main di-rection of extension of the at least one delimiting element. In other words, a longitudinal direction of the at least one recess is preferably orientated parallel to the transverse direction. Because the retaining plate and the at least one delimiting element can be provided separately, it is easily possible to mount the at least one delimiting element transversely to a longitudinal direction of the at least one recess.

In a preferred embodiment, the retaining plate has a plurality of recesses and the at least one delimiting element spans the plurality of recesses in the main direction of extension of the at least one delimiting element. The plurality of recesses and the at least one delimiting element thus form a plurality of retainers. In this way, a carrier having the aforementioned advantages and comprising a plurality of retainers can be provided in a particularly simple manner. At the same time, it is possible to produce a plurality of packaging items simultaneously. The at least one de-limiting element does not necessarily have to be connected to the retaining plate between all of the plurality of recesses. Preferably, however, the at least one delimiting element is securely connected to the retaining plate on both sides of the at least one recess, in particular on both sides of each recess which it spans. This results in a particularly rigid construction.

In general, the at least one recess may have any shape which corresponds to the peripheral shape of the packaging item. The at least one delimiting element is then orientated to span the at least one recess and therefore reliably supports the packaging item.

The plurality of recesses includes the at least one recess. All features and information described herein with respect to the at least one recess apply to each of the plurality of recesses in an analogous manner, and vice versa. The plurality of recesses is preferably arranged in a row. In particular, the recesses of the plurality of recesses may be arranged next to one another in a direction parallel to the main direction of extension of the at least one delimiting element. A longitudinal direction of the plurality of recesses may be orientated parallel to the transverse direction. It is also possible for the plurality of recesses to be arranged in several rows, in parallel or offset with respect to each other.

Advantageously, the at least one delimiting element comprises a base section extending in the main direction of extension and spanning the at least one recess at a distance from the lower side of the retaining plate. On both sides of the at least one recess, a respective web extends from the base section towards the lower side of the retaining plate and is connected to the retaining plate. The base section can therefore, in sections, form a bottom of the retainer formed by the at least one delimiting element and the at least one recess, whereupon a formed blank or the packaging tray can be reliably secured against slipping through. By means of the secure connection to the retaining plate the latter is reinforced. Because the at least one delimiting element comprises the base section and the webs, the retaining plate can be formed particularly simply by a flat plate. Preferably, a distance of the base section to the upper side of the retaining plate substantially corresponds to a depth of the packaging item, whereupon the carrier is particularly suitable for use as a die for forming the blank and for fixing the packaging tray. Advantageously, the webs extend perpendicularly to the main direction of extension and perpendicularly to the lower side of the retaining plate.

If the retaining plate has a plurality of recesses, the at least one delimiting element preferably has a plurality of webs which are connected via the base section. More preferably, one web of the plurality of webs is arranged between every two adjacent recesses of the plurality of recesses. In this manner, the at least one delimiting element can be securely connected to the retaining plate between every pair of two adjacent recesses, whereupon a particularly stable and rigid construction is obtained. However, it would also be possible to envisage that the base section could span several recesses of the plurality of recesses, for example two or three recesses, and have only one web extending towards the lower side of the retaining plate after these several recesses.

In general, the retaining plate and the at least one delimiting element can be formed as separate components. The at least one delimiting element can be connected to the retaining plate in different ways. For example, the at least one delimiting element could be welded, clamped, soldered, bonded, riveted, force-fitted or screwed to the retaining plate. A durable and reliable connection is preferred which can also be realized with a small width of the at least one delimiting element.

According to a second aspect of the present disclosure, a device for producing and/or transporting blanks, packaging trays or packaging items comprises at least one processing device for processing blanks, packaging trays or packaging items, and a conveying device which comprises a plurality of carriers according to the first aspect of the present invention. The conveying device is configured to move the plurality of carriers through the device, in particular through the at least one processing device, in sequence in a throughput direction.

In this manner, the advantages of the carrier described above come to the fore when using the carrier in the device, in particular when the plurality of carriers transport blanks, packaging trays or packaging items through processing devices, such as a forming device and/or a sealing device, for example.

Preferably, the conveying device moves the plurality of carriers through the device in a clocked manner. The throughput direction is preferably substantially linear. The plurality of carriers is then moved in the throughput direction through the device substantially in translation until packaging items or packaging parts are unloaded from the device. The plurality of carriers can then be returned in a direction opposite to the throughput direction. In another embodiment, the throughput direction can be a rotational direction. The processing devices can then be disposed in a circle.

Preferably, the at least one processing device comprises a forming device which has at least one forming tool, wherein the carriers of the plurality of carriers each form a die or support a die which die is configured to cooperate with the at least one forming tool. Each forming tool is con-figured to form a blank into a retainer of a carrier located in the forming device, the retainer be-ing formed by a recess in the retaining plate and the at least one delimiting element. The device as well as the production of packaging items therewith can therefore be realized in a simple and cost-effective manner. In the forming device, formed blanks are securely and reliably retained in the retainer formed by the at least one recess and the at least one delimiting element, and are prevented from falling through the at least one recess by the at least one delimiting element. At the same time, the at least one delimiting element reinforces the retaining plate and therefore ensures stable support of the blanks during forming.

Preferably, the at least one processing device comprises a connecting device for connecting flaps of the blank or for connecting an inlay and/or cover with the blank or the packaging tray. For example, the connecting device can be a sealing device or a gluing device, as will be described below.

The at least one processing device preferably comprises at least one sealing device, more preferably a plurality of sealing devices, for example for sealing flaps of the blank, in particular dust flaps, for sealing inlays and/or for sealing covers, in particular a cover flap or cover card. The at least one delimiting element prevents the formed blank or the packaging tray from falling through the at least one recess during sealing, as well as during further transport. At the same time, the at least one delimiting element reinforces the retaining plate and therefore ensures a stable support for the blanks or packaging trays during sealing. Because the width of the at least one delimiting element is smaller than a dimension of the at least one recess parallel to the transverse direction, a blank formed into the retainer is accessible from both sides of the at least one delimiting element, for example by tools for sealing an inlay to a formed blank or for sealing dust flaps of the blank.

It should be understood that, as an alternative to or in combination with sealing, other technologies such as hot gluing, wet gluing or bonding, for example, may be used. As an example, in addition to or as an alternative to the sealing device, the at least one processing device could comprise a gluing device for gluing flaps, inlays or covers to the blank or the packaging tray. The gluing device may comprise a gluing tool for applying glue.

In one embodiment, the at least one processing device comprises a sealing device which has a sealing tool, wherein the carriers of the plurality of carriers, in particular the retaining plates of the plurality of carriers, are configured to cooperate with the sealing tool. Preferably, the sealing de-vice serves to seal a cover such as a cover flap or a cover card, for example, to a blank formed into the at least one retainer of the carrier or an inserted packaging tray and may also be referred to as a cover sealing device. To this end, the formed blank or the inserted packaging tray may have a sealing edge which preferably sits on the upper side of the retaining plate. In this manner, the carrier acts as an abutment or as a support surface for the sealing edge, and the sealing tool can apply the pressure necessary for sealing. Preferably, the sealing tool is movably mounted in a direction perpendicular to the upper side of the retaining plate of the carrier arranged in the sealing device.

The at least one processing device may comprise an inlay sealing device having a first sealing tool and a second sealing tool which cooperate in order to seal an inlay to the blank or the pack-aging tray, wherein the first sealing tool is movable into the at least one recess of a carrier, in particular of the carrier of the plurality of carriers which is arranged in the inlay sealing device, and the second sealing tool is movable towards the lower side of the retaining plate of the carrier at a distance in the transverse direction from the at least one delimiting element. The second sealing tool may be configured to capture the formed blank below the retaining plate and to apply pressure and/or heat to the blank in order to seal the inlay to the blank. Because the at least one delimiting element only covers a small region of the formed blank, the remainder of the blank is freely accessible to the second sealing tool. Inlays can therefore be sealed to the blank at the desired locations particularly easily. Inlays serve to support and/or separate products inside a packaging item. In the throughput direction, the inlay sealing device is preferably arranged behind the forming device and before the sealing device.

The at least one processing device may furthermore comprise a supply device which is configured to introduce at least one product into the formed blank or the packaging tray. Thereby, the formed blank or the packaging tray is supported by the at least one delimiting element, so that the blank is securely retained in the carrier even when loaded by the weight of the at least one product, and cannot fall through the recess. In the throughput direction, the supply device is preferably arranged behind the inlay sealing device and before the cover sealing device.

According to a third aspect of the present disclosure, a method for producing and/or transporting blanks, packaging trays or packaging items comprises the steps of: arranging a carrier according to the first aspect of the present disclosure with at least one formed blank retained therein or a packaging tray retained therein in a connecting device, in particular by means of the conveying device; placing a cover, in particular a cover flap or a cover card, on the blank or on the packaging tray, such that a first connecting region of the blank or of the packaging tray and a second connecting region of the cover coincide; and connecting the cover to the blank or to the packaging tray by means of the connecting device in order to form a packaging item, wherein the blank or the packaging tray is supported from below by the at least one delimiting element and, preferably, by the retaining plate, in particular during connecting.

Preferably, the connecting device is formed by the sealing device and connecting the cover to the blank or to the packaging tray comprises sealing the cover to the blank or to the packaging tray by means of the sealing device.

Alternatively, the connecting device can be formed by the gluing device and connecting the cover to the blank or to the packaging tray comprises gluing the cover to the blank or to the packaging tray by means of the gluing device.

Preferably, the steps of the method are carried out in the given sequence. Furthermore, the method may be carried out by means of the device for producing and/or for transporting packaging items described above. All of the features described with respect to the carrier and the device may therefore be applied in an analogous manner to the method, and vice versa.

In one embodiment, the method may, prior to arranging the carrier in the connecting device, comprise the steps of: arranging the carrier in a forming device; placing a blank produced from fibre-based material above the at least one recess in the retaining plate of the carrier; pressing the blank into the recess by means of a forming tool of the forming device and thereby forming the blank into the recess, wherein the formed blank is supported from below by the at least one delimiting element.

Arranging the carrier in the forming device is preferably carried out by means of the conveying device. Placing the blank over the at least one recess is preferably carried out by means of the forming tool. To this end, the forming tool may comprise the pickup device which, for example, is formed by a suction device or a gripping device for engaging the blank.

By forming the blank into the recess, a packaging tray is formed for retaining a product. The packaging tray may be surrounded by a sealing edge which sits on the upper side of the retaining plate.

After forming the blank into the recess, the method may furthermore comprise the steps of: moving the carrier with the packaging tray retained therein to an inlay sealing device and arranging the carrier in the inlay sealing device, in particular by means of the conveying device; placing an inlay in the packaging tray, preferably by means of a handling device; sealing the inlay onto the packaging tray by means of the inlay sealing device, wherein, preferably, the first sealing tool is moved into the at least one recess of the carrier and acts on the inlay and the second sealing tool is moved towards the lower side of the retaining plate of the carrier at a distance in the transverse direction from the at least one delimiting element and acts on the blank from outside.

As an alternative to the inlay sealing device, an inlay gluing device having at least one gluing tool may be provided for gluing the inlay to the packaging tray.

Furthermore, the method may comprise supplying at least one product into the formed blank, in particular to the packaging tray which has been formed. In the event of an inlay being provided, supplying of the at least one product is preferably performed after sealing or gluing the inlay.

In general, the carrier may comprise a plurality of positioning elements which are disposed on the upper side of the retaining plate. The plurality of positioning elements is preferably disposed in a manner such that a cover placed on the retaining plate is positioned so that the first connecting region of the packaging tray or of the blank and the second connecting region of the cover coincide. The plurality of positioning elements may be formed by pins, bars or other shaped parts.

### BRIEF DESCRIPTION OF THE DRAWINGS

FIG. 1 is a schematic diagram of a device for producing packaging items.

FIG. 2 is a perspective view from above of a carrier with a packaging item retained therein.

FIG. 3 is a side view of the carrier of FIG. 2.

FIG. 4 is a perspective detailed view from below of the carrier of FIGS. 2 and 3 with a formed blank.

FIGS. 5a-e are schematic sectional views of the carrier in processing devices of the device of FIG. 1 or during a method for producing packaging items.

### DETAILED DESCRIPTION

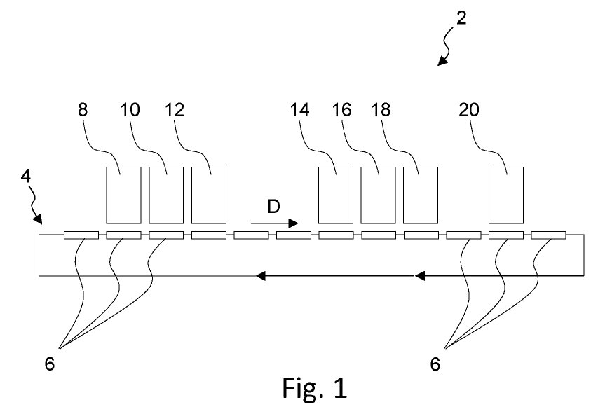

FIG. 1 schematically shows a device 2 for producing packaging items from a fibre-based material-al or from plastic. The device 2 comprises at least one processing device 8, 10, 12, 14, 16, 18, 20 for processing blanks or packaging trays, and a conveying device 4 which comprises a plurality of carriers 6 for transporting blanks or packaging trays. The plurality of carriers 6 may be arranged consecutively and be moved through the device 2 in a throughput direction D in order to transport the blanks or the packaging trays through the at least one processing device 8, 10, 12, 14, 16, 18, 20. The device 2 and the carrier 6 will be described below, by way of example, with respect to retaining and processing a blank. It should be understood that the exemplary embodiment applies analogously to retaining and processing a packaging tray. Such a packaging tray may be pre-formed and inserted into the device 2 or may be provided by forming a blank, as outlined below.

In the embodiment shown, the device 2 comprises a plurality of processing devices such as, for example, a forming device 8 for forming a blank into a packaging part, such as a packaging tray, a dust flap sealing device 10 for sealing dust flaps of the blank, an inlay sealing device 12 for sealing an inlay into a formed blank, a supply device 14 for supplying at least one product into the formed blank, a handling device 16 for positioning a cover on the formed blank, a sealing device 18 for sealing the cover to the formed blank, and an unloading device 20 for unloading a packaging item from the device 2. Because in this embodiment a packaging item filled with a product and closed by a cover is produced, the device 2 may also be referred to as a packaging machine. However, the device 2 may also comprise only some of the processing devices 8, 10, 12, 14, 16, 18, 20. Individual processing steps such as, for example, sealing dust flaps or inlays, are optional and may be omitted. On the other hand, forming the blanks or sealing the cover to the blank could be carried out in a separate device, for example.

It is particularly advantageous for the plurality of carriers 6 to support the processing of the blanks in the plurality of processing devices 8, 10, 12, 14, 16, 18, 20, in particular by cooperating with the respective tools provided therein, such as forming and sealing tools, for example. This results in various requirements to be achieved by the carriers 6. On the one hand, for example, the carriers 6 should sufficiently support and securely retain the blanks during forming, sealing and transporting. On the other hand, the carriers 6 should allow the tools used to have good access to the blanks. In addition, it is desirable for the carriers 6 to be capable of being produced in a simple and cost-effective manner.

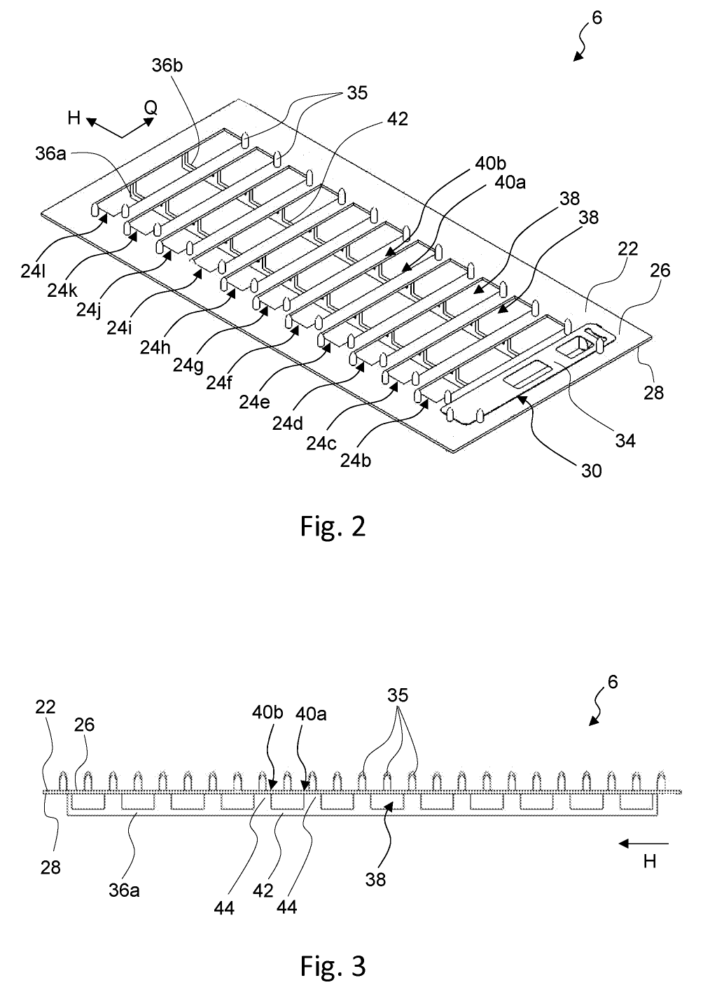

One embodiment of a carrier 6 which meets these requirements is shown in FIGS. 2 to 4. The carrier 6 comprises a retaining plate 22 having at least one recess 24, here a plurality of recesses 24a-l, which penetrates the retaining plate 22 from an upper side 26 to a lower side 28 of the retaining plate 22. The plurality of recesses 24a-l can be arranged in a row or in a matrix of several rows and columns or in any other position, for example in a cascaded position.

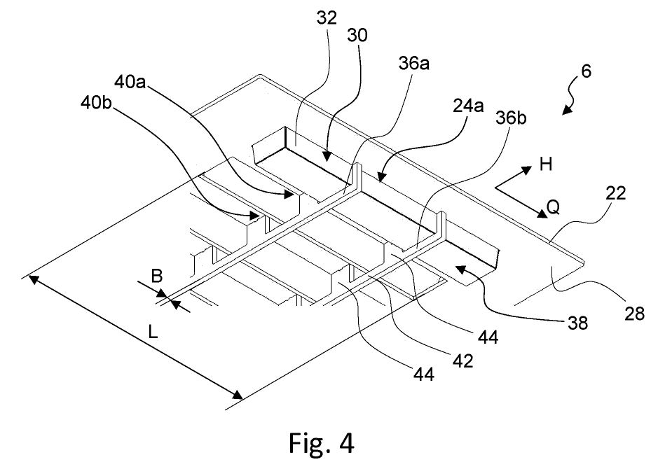

In FIGS. 2 and 4, a packaging item 30 is shown by way of example, which is retained in the carrier 6. One packaging item 30 may be retained in each recess 24a-l, but is not shown in order to better illustrate the components of the carrier 6. Here, the packaging item 30 comprises a blank 32, which has already been formed into the recess 24, and a cover in the form of a cover card 34, which is sealed to the blank 32. It should be understood that the packaging item 30 is not limited to the embodiment shown and the carrier 6 is not limited to being used therewith.

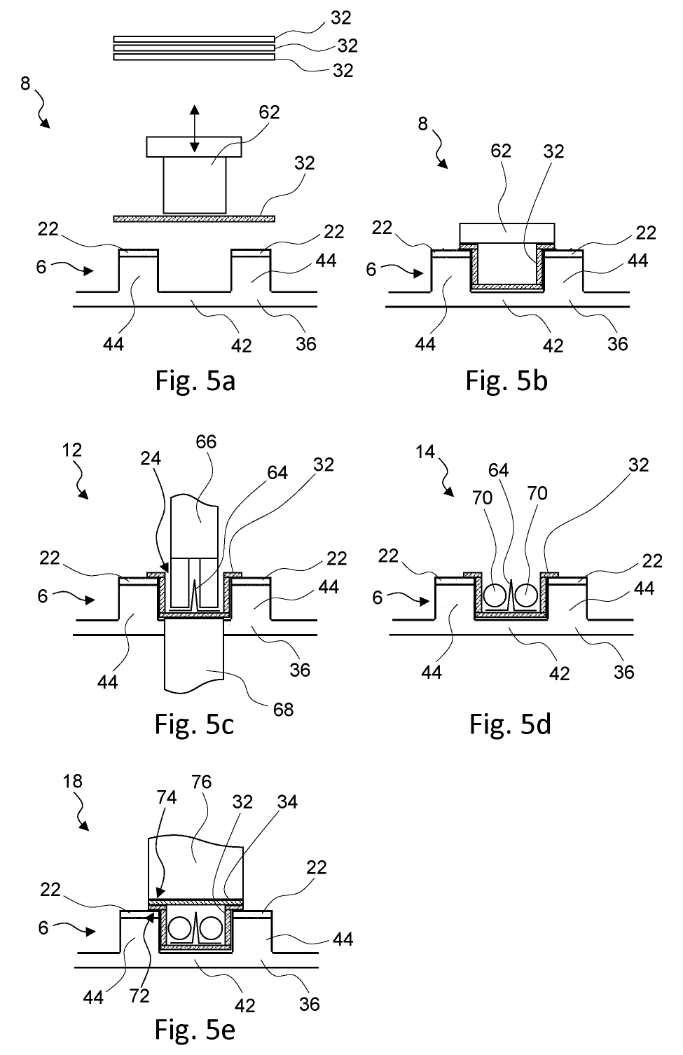

In general, it is advantageous for the peripheral shape of the plurality of recesses 24a-l to substantially correspond to a peripheral shape of the packaging items 30 to be produced. In this way, the packaging item 30 is retained in a particularly secure manner and the carrier 6 is suitable for use as a die within the forming device 8, as will be described in greater detail below with reference to FIG. 5.

Preferably, a plurality of positioning elements is provided on the upper side 26 of the retaining plate 22, wherein the positioning elements are formed by pins 35 in the embodiment shown. FIGS. 2 and 3 clearly show that the positioning elements 35 surround the cover card 34 placed on the carrier 6, so that the cover card 34 is precisely positioned on the retaining plate 22 when it is placed thereon.

Furthermore, the carrier 6 comprises at least one delimiting element 36, in this case two delimiting elements 36a, 36b which are spaced apart from each other. The delimiting elements 36a, 36b are attached to the lower side 28 of the retaining plate 22 and respectively span the plurality of recesses 24a-l in a main direction of extension H of the delimiting elements 36a, 36b. Together with the delimiting elements 36a, 36b, each recess 24a-l forms a retainer 38 for a blank 32 formed into the retainer 38, wherein the retainer 38 is delimited from below by the delimiting elements 36a, 36b. In general, instead of a formed blank 32, the retainer 38 may also receive a pre-formed packaging tray.

Each delimiting element 36a, 36b has a width B in a transverse direction Q which is significantly smaller than a dimension L of the recesses 24a-l parallel to the transverse direction Q, as can be seen in FIG. 4. In general, the transverse direction Q is orientated parallel to the retaining plate 22, in particular to its lower side 28, and perpendicular to the main direction of extension H. As an example, the width B of the delimiting elements 36a, 36b may be between 2 mm and 4 mm.

As can clearly be seen in FIG. 4, the delimiting elements 36a, 36b support the formed blank 32 from below, so that the latter is securely and reliably retained in the carrier 6 and cannot slip through the recess 24, while at the same time, the blank 32 is also readily accessible below the retaining plate 22. The carrier 6 thus enables optimal processing of the blank 32 within further processing devices as well, in particular within the dust flap sealing device 10 or the inlay sealing device 12.

Each recess 24a-l is limited by at least two opposing edge areas 40a, 40b of the retaining plate 22. Each of the delimiting elements 36a, 36b preferably extends from one edge area 40a to the other edge area 40b, thereby forming the retainer 38. A preferred embodiment of the delimiting element 36 will be described below with reference to FIGS. 2 to 4.

The at least one delimiting element 36 may comprise a base section 42 which extends in the main direction of extension H and spans the at least one recess 24 at a distance from the lower side 28 of the retaining plate 22. A respective web 44 extends from the base section 42 on both sides of the recess 24 towards the lower side 28 of the retaining plate 22. In this way, the delimit-ing element 36 forms a substantially U-shaped retainer 38. High rigidity of the carrier 6 is preferably obtained by connecting the delimiting elements 36a, 36b to the retaining plate 22 between each pair of adjacent recesses 24a-l by means of one web 44. Preferably, the webs 44 are connected to the retaining plate 22 by means of a screw connection. In general, however, other connecting techniques, such as soldering, welding, riveting or clamping, may be employed.

As described above, the carrier 6 is particularly suitable for retaining and transporting the blanks 32 and packaging items 30 in the device 2 or during a method for producing packaging items, as will be described below in greater detail with the reference to FIG. 5.

In FIG. 5a, a section of a carrier 6 with a blank 32 is schematically shown in the forming device 8. Initially, the blank 32 has a flat shape so as to be stored and transported in a space-saving manner. A plurality of blanks 32 may be provided in a magazine, as indicated by the three blanks 32 shown in the upper region of FIG. 5a. One blank 32 is preferably engaged by a forming tool 62 of the forming device 8 and removed from the magazine. It should be understood that another handling device could initially engage the blank 32 and place it on the carrier 6. The forming tool 62 places the blank 32 above the recess 24 provided in the retaining plate 22.

As can be seen in FIG. 5b, the carrier 6 forms a die and cooperates with the forming tool 62. In more detail, the blank 32 is pressed through the recess 24 by means of the forming tool 62 and is therefore formed into the retainer 38. The blank 32, which has therefore been formed, is supported from below by the delimiting element 36 of the carrier 6. The formed blank 32 forms a packaging tray for receiving products.

In order to support and/or separate products within the packaging item 30 to be produced, in some embodiments, it is desirable to seal an inlay 64 to the formed blank 32. To this end, the carrier 6 with the formed blank 32 retained therein is moved to an inlay sealing device 12 and arranged therein, as shown in FIG. 5c. In the inlay sealing device 12, firstly, the inlay 64 is placed in the formed blank 32. Next, a first sealing tool 66 is moved into the recess 24 and therefore into the formed blank 32, and a second sealing tool 68 is moved towards the lower side 28 of the retaining plate 22 in order to act on the blank 32 from outside. The first sealing tool 66 and the second sealing tool 68 seal the inlay 64 to the blank 32. FIG. 4 and FIG. 5c taken together show that, because of the shape of the delimiting elements 36a, 36b, large regions of the lower side of the blank 32 can readily be accessed by the second sealing tool 68. Instead of the inlay sealing device 12, an inlay gluing device having at least one appropriate gluing tool could be provided.

Next, in the supply device 14, products 70 can be inserted into the packaging tray formed by the formed blank 32 in a known manner, as shown in FIG. 5d. It should be understood that only one product could also be supplied and retained in the packaging item. In any case, the delimiting elements 36a, 36b secure the formed blank 32 or the packaging tray so that it does not fall through the recess 24 of the retaining plate 22 even when loaded with the weight of the products 70.

Finally, the carrier 6 with the filled blank 32 or packaging tray, respectively, retained in the carrier 6 can be moved into the sealing device 18 and arranged therein, as shown in FIG. 5e. In the seal-ing device 18 or even before, the cover card 34 can be placed on the formed blank 32, as can also be seen in FIG. 2. The cover card 34 is in particular positioned by the positioning elements 35 in a manner such that a preferably peripheral first sealing region 72 of the blank 32 and a prefer-ably peripheral second sealing region 74 of the cover card 34 coincide. Next, the cover card 34 can be sealed to the formed blank 32 by means of a sealing tool 76 of the sealing device 18. The retaining plate 22 supports the first sealing region 72 of the blank 32 during sealing and is rein-forced by the delimiting elements 36a, 36b. The packaging item 30 is now finished and can be unloaded from the device 2 by means of the unloading device 20. Instead of the sealing device 18, a gluing device with at least one appropriate gluing tool could be provided.

Further embodiments of the carrier 6, the device 2 and the method can be envisaged by the per-son skilled in the art on the basis of the detailed description of preferred exemplary embodiments contained herein.

1. A carrier for retaining and transporting blanks, packaging trays and packaging items, wherein the carrier comprises:
a retaining plate having at least one recess which penetrates the retaining plate from an upper side to a lower side of the retaining plate; and
at least one delimiting element which is attached to the lower side of the retaining plate and spans the at least one recess, wherein the at least one recess and the at least one delimiting element form a retainer for a blank formed into the retainer, an inserted packaging tray or packaging item, the retainer being delimited at a bottom by the at least one delimiting element;
wherein the at least one delimiting element has a main direction of extension and a width, wherein the width is defined in a transverse direction perpendicular to the main direction of extension of the at least one delimiting element and is smaller than a dimension of the at least one recess parallel to the transverse direction.

2. The carrier of claim 1, wherein the carrier comprises a plurality of delimiting elements which are arranged at a distance from each other in the transverse direction.

3. The carrier of claim 1, wherein the retaining plate has a plurality of recesses and the at least one delimiting element spans the plurality of recesses in the main direction of extension of the at least one delimiting element, wherein the plurality of recesses and the at least one delimiting element form a plurality of retainers.

4. The carrier of claim 1, wherein the at least one delimiting element comprises a base section extending in the main direction of extension and spanning the at least one recess at a distance from the lower side of the retaining plate, wherein, on both sides of the at least one recess, a respective web extends from the base section towards the lower side of the retaining plate and is connected to the retaining plate.

5. The carrier of claim 4, wherein the at least one delimiting element has a plurality of webs which are connected via the base section, wherein one web of the plurality of webs is arranged between every two adjacent recesses of the plurality of recesses.

6. The carrier of claim 1, wherein the width of the at least one delimiting element is between 1 mm and 8 mm.

7. The carrier of claim 1, wherein the at least one recess has an elongated shape and is orientated such that the at least one recess extends further parallel to the transverse direction than parallel to the main direction of extension of the at least one delimiting element.

8. A device for producing and/or transporting blanks, packaging trays or packaging items, comprising:
at least one processing device for processing blanks, packaging trays or packaging items; and
a conveying device, which comprises a plurality of carriers of claim 1 and which is configured to move the plurality of carriers through the device in sequence in a throughput direction.

9. The device of claim 8, wherein the at least one processing device comprises a forming device which has a forming tool, wherein the carriers of the plurality of carriers each form a die which is configured to cooperate with the forming tool.

10. The device of claim 8, wherein the at least one processing device comprises a sealing device which has a sealing tool, wherein the carriers of the plurality of carriers are configured to cooperate with the sealing tool.

11. The device of claim 8, wherein the at least one processing device comprises an inlay sealing device having a first sealing tool and a second sealing tool which cooperate in order to seal an inlay to the blank or to the packaging tray, wherein the first sealing tool is movable into the at least one recess of a carrier of the plurality of carriers and the second sealing tool is movable towards the lower side of the retaining plate of the carrier at a distance in the transverse direction from the at least one delimiting element.

12. The device of claim 8, wherein the at least one processing device comprises a gluing device having a gluing tool, wherein the carriers of the plurality of carriers are configured to cooperate with the gluing tool.

13. A method for producing and/or transporting blanks, packaging trays or packaging items, the method comprising the steps of:
arranging a carrier of claim 1 with at least one formed blank retained therein or with a packaging tray retained therein in a connecting device;
placing a cover on the blank or on the packaging tray, such that a first connecting region of the blank or of the packaging tray and a second connecting region of the cover coincide; and
connecting the cover to the blank or to the packaging tray by means of the connecting device in order to form a packaging item, wherein the blank or the packaging tray is supported from below by the at least one delimiting element.

14. The method of claim 13, wherein the connecting device is a sealing device and connecting the cover to the blank or to the packaging tray comprises sealing the cover to the blank or to the packaging tray by means of the sealing device.

15. The method of claim 13, wherein the connecting device is a gluing device and connecting the cover to the blank or to the packaging tray comprises gluing the cover to the blank or to the packaging tray by means of the gluing device.

16. The method of claim 13, wherein prior to arranging the carrier in the connecting device, the method further comprises the steps of:
arranging the carrier in a forming device;
placing a blank produced from fibre-based material above the at least one recess in the retaining plate of the carrier;
pressing the blank into the recess by means of a forming tool of the forming device and thereby forming the blank into the recess, wherein the formed blank is supported from below by the at least one delimiting element.
